(19) United States
(12) Patent Application Publication
(10) Pub. No.: US 2026/0196436 A1
(43) Pub. Date: Jul. 9, 2026

(54) ROTATING ANODE FOR X-RAY TUBE, X-RAY TUBE, X-RAY INSPECTION APPARATUS, AND METHOD FOR MANUFACTURING ROTATING ANODE FOR X-RAY TUBE

(71) Applicant: Niterra Materials Co., Ltd., Yokohama-shi (JP)

(72) Inventors: Masanori MIZOBE, Yokohama (JP); Shinichi YAMAMOTO, Fujisawa (JP); Makoto ANDO, Yokohama (JP); Hitoshi AOYAMA, Yokohama (JP)

(73) Assignee: Niterra Materials Co., Ltd., Yokohama-shi (JP)

(21) Appl. No.: 19/556,227

(22) Filed: Mar. 4, 2026

Related U.S. Application Data
(63) Continuation of application No. PCT/JP2024/034648, filed on Sep. 27, 2024.

(30) Foreign Application Priority Data
Sep. 29, 2023 (JP) 2023-170807

(51) Int. Cl. H01J 35/10; H01J 9/02

(52) U.S. Cl. CPC H01J 35/10; H01J 9/02; H01J 2235/081; H01J 2235/088

(57) ABSTRACT

A rotating anode for an X-ray tube according to embodiments includes, as a laminate, at least a target layer receiving thermal electrons and generating X-rays, a first base layer, and a second base layer. The target layer is mainly including at least one of tungsten, molybdenum, niobium, tantalum, rhenium, titanium, zirconium, or vanadium. The first base layer is mainly including molybdenum and contains at least one carbide selected from titanium carbide, hafnium carbide, zirconium carbide, tantalum carbide, and niobium carbide. The second base layer is mainly including molybdenum and has lower oxygen and carbon contents than the first base layer.

### CROSS-REFERENCE TO RELATED APPLICATION

This application is a Continuation Application of No. PCT/JP2024/034648, filed on Sep. 27, 2024, and the PCT application is based upon and claims the benefit of priority from Japanese Patent Application No. 2023-170807, filed on Sep. 29, 2023, the entire contents of which are incorporated herein by reference.

### FIELD

Embodiments of the present invention relate to a rotating anode for an X-ray tube, an X-ray tube, an X-ray inspection apparatus, and a method for manufacturing a rotating anode for an X-ray tube.

### BACKGROUND

To generate X-rays from an X-ray tube, an electric current is supplied to the filament of the cathode to heat the cathode, and the thermal electrons emitted by the heating are accelerated by a high voltage (also referred to as tube voltage) applied between the cathode and the anode (target), and caused to collide with the target layer of the anode. X-rays are generated by the collision of the thermal electrons with the target layer. In rotating-anode X-ray tubes, the anode is rotated at high speed to an extent that does not impair the durability of the X-ray tube, in order to obtain the X-ray output required by the market.

A rotating anode for an X-ray tube has a laminated structure including a target layer and a high-strength base layer. As a molybdenum (Mo) alloy with improved high-temperature strength, a TZM alloy consisting of 0.5 wt % Ti, 0.07 wt % Zr, 0.05 wt % carbon, and the balance Mo is known. Because the melting point of molybdenum, the principal component, is high, the TZM alloy exhibits excellent high-temperature strength. Utilizing this characteristic, it is used in fields requiring high-temperature strength properties, such as rotating anodes for X-ray tubes.

However, when this TZM alloy is used as a rotating anode for an X-ray tube, the gas-release characteristics of the base layer are insufficient, and impurities such as oxygen and carbon in the alloy are gasified, resulting in the problem that the number of discharges in the gas inside the X-ray tube becomes high.

### BRIEF DESCRIPTION OF THE DRAWINGS

FIG. 1 is a schematic top view showing an example structure of a rotating anode for an X-ray tube according to the embodiment.

FIG. 2 is a schematic cross-sectional view taken along line II-II in FIG. 1, showing an example structure of the rotating anode.

FIG. 3 is a schematic side view showing another example structure of the rotating anode according to the embodiment.

FIG. 4 is a cross-sectional view similar to FIG. 2, illustrating a first modification example of the rotating anode structure.

FIG. 5 is a cross-sectional view similar to FIG. 2, illustrating a second modification example of the rotating anode structure.

FIG. 6 is a cross-sectional view similar to FIG. 2, illustrating a third modification example of the rotating anode structure.

FIG. 7 is a cross-sectional view similar to FIG. 2, illustrating a fourth modification example of the rotating anode structure.

FIG. 8 is a schematic diagram showing the configuration of an X-ray tube incorporating the rotating anode according to the embodiment.

FIG. 9 is a schematic cross-sectional view taken along line II-II of a rotating anode used in Comparative Example 2.

### DETAILED DESCRIPTION

Hereinafter, embodiments of a rotating anode for an X-ray tube, an X-ray tube, an X-ray inspection apparatus, and a method for manufacturing the rotating anode for an X-ray tube will be described in detail with reference to the drawings.

A rotating anode for an X-ray tube according to embodiments includes, as a laminate, at least a target layer receiving thermal electrons and generating X-rays, a first base layer, and a second base layer. The target layer is mainly including at least one of tungsten, molybdenum, niobium, tantalum, rhenium, titanium, zirconium, or vanadium. The first base layer is mainly including molybdenum and contains at least one carbide selected from titanium carbide, hafnium carbide, zirconium carbide, tantalum carbide, and niobium carbide. The second base layer is mainly including molybdenum and has lower oxygen and carbon contents than the first base layer.

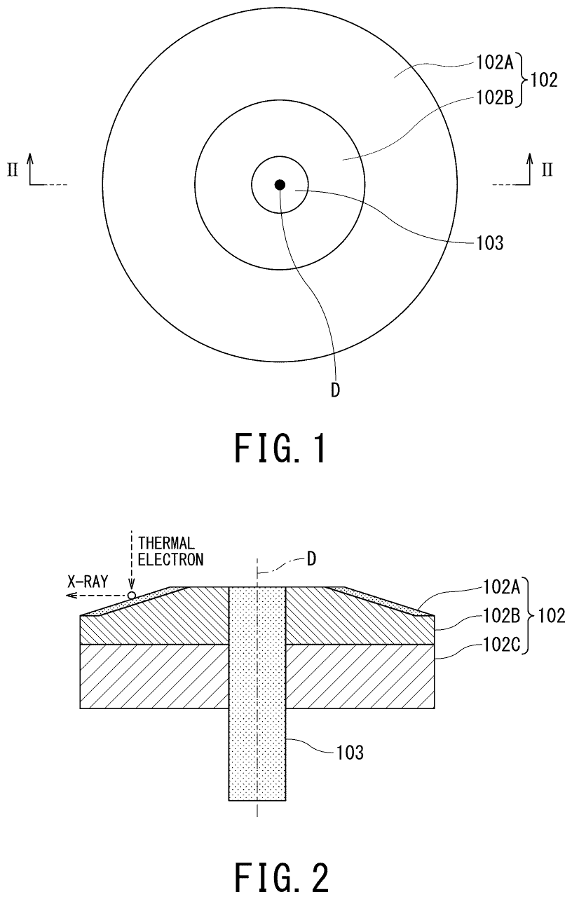

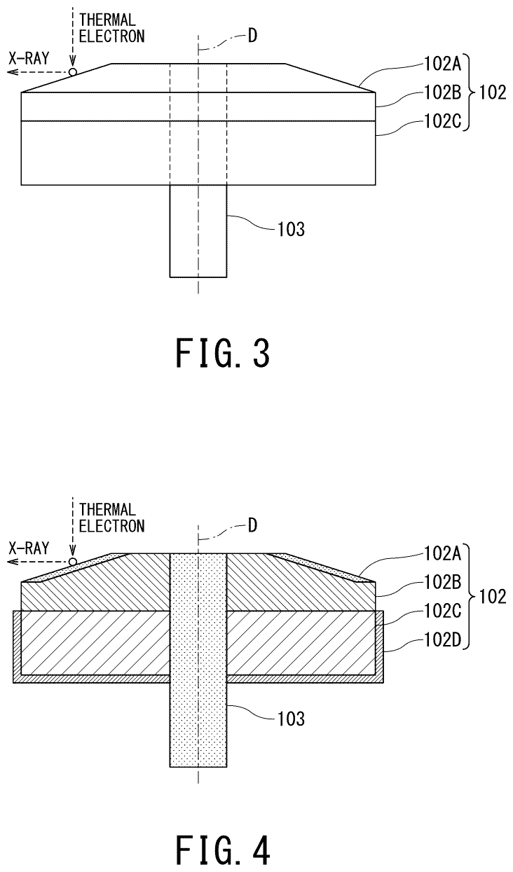

FIG. 1 is a top view illustrating an example structure of a rotating anode for an X-ray tube according to the embodiment. FIG. 2 is a sectional view taken along line II-II illustrating an example structure of the rotating anode according to the embodiment. FIG. 3 is a side view illustrating an example structure of the rotating anode according to the embodiment. FIGS. 4 to 7 illustrate other examples of the structure of the rotating anode shown in FIG. 2 in sectional views taken along line II-II.

FIGS. 1 to 7 show a rotating anode 102 (hereinafter simply referred to as “anode”) according to the embodiment, and a rotor 103. The anode 102 has a through-hole having a cylindrical shape for inserting the rotor 103, with the thickness direction defined as the height direction. The anode 102 is formed by at least laminating a target layer 102A, a first base layer (carbide-added layer) 102B, and a second base layer (pure molybdenum layer) 102C. That is, the anode 102 has at least a three-layer structure.

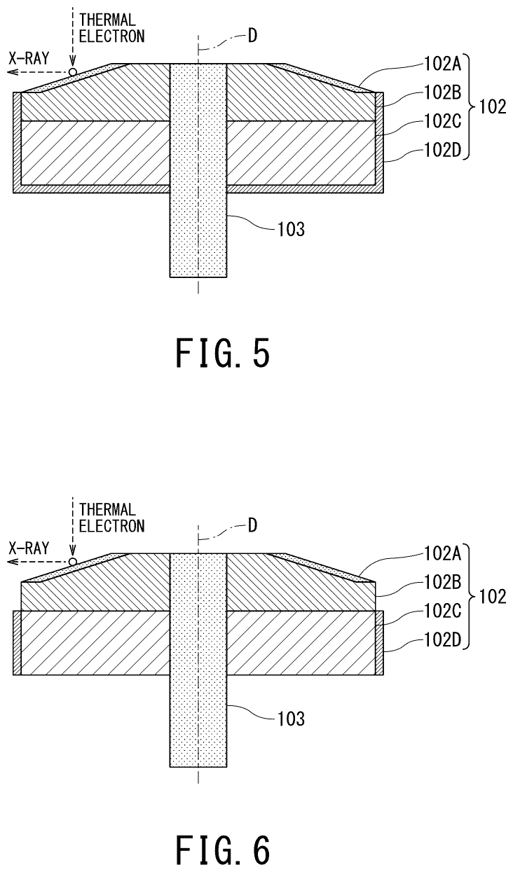

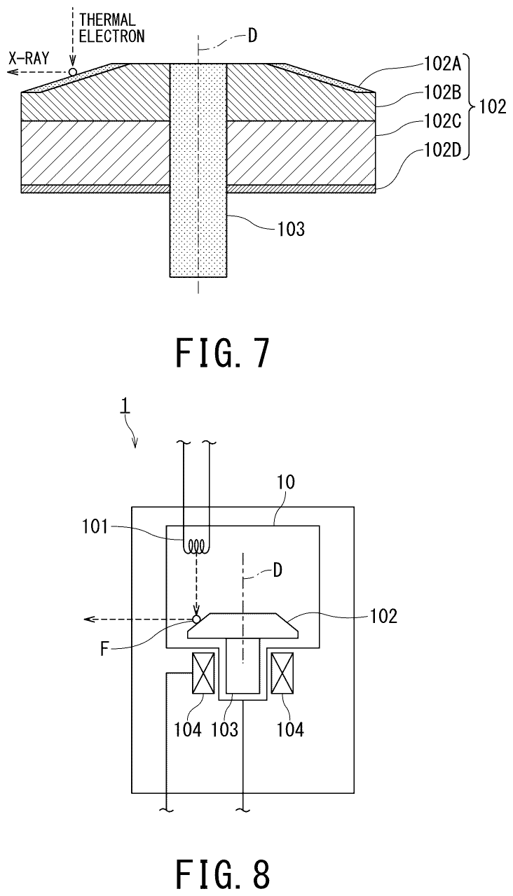

The anode 102 may further include a coating material 102D on at least a part of the surface excluding the upper surface of the anode 102. As shown in FIGS. 4-7, the direction in which the first base layer 102B is laminated on the second base layer 102C is defined as the upper side (the upper side of the drawing sheet in FIGS. 4-7). FIGS. 4 to 7 each illustrate examples in which the coating material 102D is provided on at least a part or the whole of the side surface or the back surface of the anode 102, and each figure shows an example of different placement of the coating material 102D. The coating material 102D may be provided on the entire (or partial) side surface of the second base layer 102C and the entire (or partial) back surface of the anode 102 (as shown in FIG. 4), or on the entire (or partial) side surface of the anode 102 and the entire (or partial) back surface of the anode 102 (as shown in FIG. 5). Alternatively, the coating material 102D may be provided only on the entire (or partial) side surface of the second base layer 102C (as shown in FIG. 6), only on the entire (or partial) back surface of the anode 102 (as shown in FIG. 7), or a combination thereof.

The coating material 102D may include oxide ceramics. Examples of the oxide ceramics include titanium oxide, aluminum oxide, silicon oxide, and zirconium oxide. The oxide ceramics may also be a combination of two or more types. Examples of combinations of two or more oxide ceramics include Ti₂O₃—Al₂O₃. Unless otherwise noted, the explanation will be given on the case of FIG. 2 rather than FIG. 4.

The anode 102 is an electrode having a generally disk-like shape. The anode 102 rotates in accordance with the rotation of the rotor 103 around the rotational center axis D. A high tube voltage is applied between the cathode 101 (shown in FIG. 8) and the anode 102. Thermal electrons emitted from the cathode due to heating collide with the target layer 102A, which is the surface of the anode 102 on the cathode 101 side, under the influence of the tube voltage. The target layer 102A of the anode 102 generates X-rays upon receiving the thermal electrons.

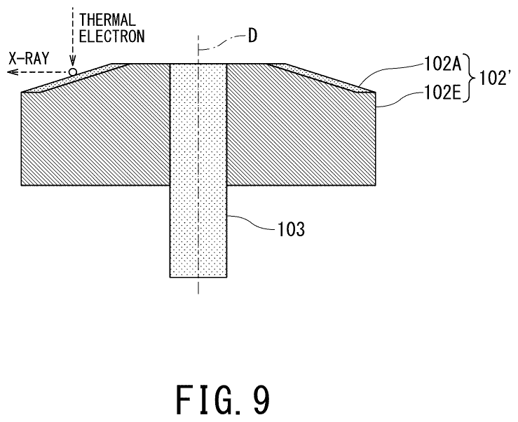

The first base layer 102B and the second base layer 102C of the anode 102 are formed by dividing the single base layer 102E of the anode 102′ of Comparative Example 2 shown in FIG. 9 into two layers in the thickness direction. That is, the combined thickness of the first base layer 102B and the second base layer 102C is approximately equal to the thickness of the single base layer 102E. Preferably, the thickness near the center of the first base layer 102B and the thickness of the second base layer 102C are approximately equal. For example, when the thickness of the base layer 102E in the anode 102′ is 20 mm, the first base layer 102B and the second base layer 102C are each 10 mm in thickness.

The target layer 102A is mainly includes at least one of tungsten (W), molybdenum (Mo), niobium (Nb), tantalum (Ta), rhenium (Re), titanium (Ti), zirconium (Zr), and vanadium (V).

The first base layer 102B contains molybdenum as a main component and includes at least one carbide selected from titanium carbide, hafnium carbide, zirconium carbide, tantalum carbide, and niobium carbide. That is, the first base layer 102B contains carbides as additives, and since unavoidable impurities such as iron (Fe) are contained in the raw powder, it has high-strength characteristics. It is preferable that the oxygen content in the first base layer 102B is 300 ppm or less, and the carbon content is 400 ppm or more and 1000 ppm or less. More preferably, the carbon content is 400 ppm or more and 600 ppm or less.

The second base layer 102C contains molybdenum as a main component and has smaller oxygen and carbon contents than the first base layer 102B. It is preferable that the oxygen content in the second base layer 102C is 30 ppm or less, and the carbon content is 400 ppm or less, and that both are smaller than those of the first base layer 102B. Since the second base layer 102C does not include carbides as additives, unlike the first base layer 102B (although unavoidable impurities may be included), the second base layer 102C has a smaller carbon content than the first base layer 102B and therefore exhibits superior gas-release characteristics. On the other hand, the anode 102′ of Comparative Example 2 shown in FIG. 9 has a single base layer 102E made of TZM alloy, which has high strength but inferior gas-release characteristics.

It is preferable that the difference in oxygen content between the first base layer 102B and the second base layer 102C is 5 ppm or more and 300 ppm or less, and more preferably ppm or more and 250 ppm or less. On the other hand, it is preferable that the difference in carbon content between the first base layer 102B and the second base layer 102C is 100 ppm or more and 300 ppm or less. It is preferable that each of the first base layer 102B and the second base layer 102C has a thickness of 0.5 mm or more, and that the ratio of the thicknesses of the first base layer 102B and the second base layer 102C is ⅙ or more and 6 or less.

The oxygen and carbon contents are measured at four locations, and the average value is used. The four measurement locations are shifted by 90 degrees on the disk and are taken from positions excluding the surface layer and bonding regions. The same measurement conditions are applied to both the first base layer 102B and the second base layer 102C. For numerical values without a lower limit, the value may be 0 (below detectable limits).

The oxygen content is measured by an inert gas fusion-infrared absorption method. The oxygen measurement is conducted using an ON836 instrument manufactured by LECO Corporation, or an instrument with equal or higher performance.

The carbon content is measured by high-frequency induction furnace combustion-infrared absorption method using an EMIA-920V2 instrument manufactured by Horiba, Ltd., or an instrument with equal or higher performance.

Since only the first base layer 102B includes carbides among the first and second base layers 102B and 102C, the crystal grain size (e.g., average crystal grain size) of the first base layer 102B is smaller than that of the second base layer 102C. This is because the addition of carbides to the first base layer 102B suppresses grain growth within the layer. The average crystal grain size of the first base layer 102B is smaller than that of the second base layer 102C and preferably 40 μm or more and 130 μm or less. For example, the average crystal grain size of the first base layer 102B is 40 μm or more and 100 μm or less. The average crystal grain size of the second base layer 102C is preferably 80 μm or more and 250 μm or less and is larger than that of the first base layer 102B. For example, the average crystal grain size of the second base layer 102C is 80 μm or more and 180 μm or less.

For example, the ratio of the average crystal grain size of the first base layer 102B to that of the second base layer 102C is less than 0.8. Preferably, the average crystal grain size of the first base layer 102B is 50 μm or more and 90 μm or less. Preferably, the average crystal grain size of the second base layer 102C is 90 μm or more and 150 μm or less. The average crystal grain sizes of the first and second base layers 102B and 102C may be determined by the intercept method. In the intercept method, the anode 102 is cut in the thickness direction, and the cross-section is polished and etched to obtain an observation surface for microscopic observation. At least three fields of view per base layer are used, avoiding biased locations.

Since only the first base layer 102B includes carbides among the first and second base layers 102B and 102C, the Vickers hardness of the first base layer 102B is greater than that of the second base layer 102C. The Vickers hardness of the first base layer 102B is greater than that of the second base layer 102C and preferably 150 Hv or more and 300 Hv or less. For example, the Vickers hardness of the first base layer 102B exceeds 205 Hv and is 300 Hv or less. The Vickers hardness of the second base layer 102C is smaller than that of the first base layer 102B and preferably 130 Hv or more and 200 Hv or less. For example, the Vickers hardness of the second base layer 102C exceeds 160 Hv and is 200 Hv or less.

The ratio of the Vickers hardness of the first base layer 102B to that of the second base layer 102C is greater than 1.1. Preferably, the ratio is greater than 1.3. The Vickers hardness of the first base layer 102B is preferably 210 Hv or more and 270 Hv or less. The Vickers hardness of the second base layer 102C is preferably 170 Hv or more and 180 Hv or less. The Vickers hardness values are based on JIS Z 2244.

The flexural strength of the first base layer 102B at room temperature is, for example, 700 MPa or greater. Preferably, the flexural strength at room temperature of the first base layer 102B exceeds, for example, 710 MPa. On the other hand, it is preferable that the flexural strength is 1500 MPa or less. If the flexural strength is too high, there is a risk of adversely affecting workability, which is undesirable. With the above configuration, sufficient strength can be obtained. The flexural strength is based on JIS R 1601.

The rotor 103 is an external member of the anode 102 and is a rotor that rotatably supports the anode 102 about a rotation axis. The rotor 103 is provided so that the anode 102 can rotate around the rotation axis.

FIG. 8 is a schematic diagram illustrating the configuration of an X-ray tube including the anode 102. In FIG. 8, components identical to those shown in FIGS. 1 to 4 are denoted by the same reference numerals and a description thereof is omitted.

FIG. 8 illustrates an X-ray tube 1 including the anode 102. The X-ray tube 1 is used in an X-ray inspection apparatus. For example, the X-ray inspection apparatus includes inspection apparatuses in the medical field (such as general radiographic imaging apparatuses, mammography apparatuses, X-ray CT (Computed Tomography) apparatuses, and X-ray therapy apparatuses), and inspection apparatuses in the scientific and industrial fields (for example, X-ray diffraction apparatuses, fluorescent X-ray analyzers, non-destructive testing apparatuses, thickness and other material inspection apparatuses, and baggage inspection apparatuses at airports). The X-ray tube 1 includes an X-ray tube housing 10. The X-ray tube housing 10 is a housing made of materials such as glass or metal whose interior is maintained under vacuum. The X-ray tube housing 10 accommodates the cathode 101, the anode 102, and the rotor 103.

The cathode 101 has, for example, a filament formed of a metal such as tungsten or nickel having a fine-wire shape. The cathode 101 is connected to an X-ray high-voltage device (not shown) via a cable or the like. The cathode 101 generates heat and emits thermal electrons upon application of a cathode voltage and supply of a filament current from the X-ray high-voltage device.

The thermal electrons emitted from the cathode 101 collide, under the influence of the tube voltage, with the focal position F of the target layer 102A of the anode 102. The target layer 102A of the anode 102 generates X-rays at the focal position F upon receiving the thermal electrons. By rotating the anode 102 about the rotation center axis D, the X-ray tube 1 generates X-rays while shifting the focal position F on the target layer 102A.

Bearings (not shown) are connected to both end portions of the rotor 103. A stator coil 104 is mounted outside the X-ray tube housing 10 so as to surround the rotor 103. The stator coil 104 is accommodated in the X-ray tube 1. The stator coil 104 is connected to a rotor drive power supply (not shown) and rotates the rotor 103 according to the principle of electromagnetic induction upon receiving power from the rotor drive power supply. In conjunction with the rotation of the rotor 103, the anode 102 rotates about the rotation center axis D.

Next, a method for manufacturing the anode 102 will be described. The method for manufacturing the anode 102 is not particularly limited, but preferred methods include the following.

First, as a raw powder for the target layer 102A of the anode 102, tungsten powder and rhenium powder are prepared and mixed by a ball mill or the like. Preferably, the content of rhenium is 2 wt % or more and 12 wt % or less. As a raw powder for the first base layer 102B of the anode 102, molybdenum powder containing unavoidable impurities and carbide powder are prepared and mixed by a ball mill or the like. The molybdenum powder contains, as unavoidable impurities, iron (Fe) in an amount of 5 ppm or more and 100 ppm or less. Preferably, the iron is 5 ppm or more and 50 ppm or less, and more preferably 5 ppm or more and 30 ppm or less. The molybdenum powder also contains, as unavoidable impurities, nickel (Ni) in an amount of 5 ppm or more and 40 ppm or less, preferably 5 ppm or more and 20 ppm or less. The molybdenum powder further contains, as unavoidable impurities, potassium (K) in an amount of 5 ppm or more and 30 ppm or less, preferably 5 ppm or more and 20 ppm or less. The total amount of unavoidable impurities of iron (Fe), nickel (Ni), and potassium (K) is 15 ppm or more and 100 ppm or less, and preferably 15 ppm or more and 60 ppm or less. The carbide powder is selected from at least one of titanium carbide, hafnium carbide, zirconium carbide, tantalum carbide, and niobium carbide, and is selected so that the total amount of carbides becomes 0.2 wt % or more and 1.5 wt % or less in the mixed powder. Since carbides are included, the first base layer 102B can maintain higher strength than the second base layer 102C. It is preferable that the average particle size of the carbide powder is smaller than the average particle size of the molybdenum powder, in order for the carbides to be more uniformly dispersed in the grain-boundary phase of molybdenum.

On the other hand, as a raw powder for the second base layer 102C of the anode 102, molybdenum powder is prepared. The molybdenum powder used for the first base layer 102B and the molybdenum powder used for the second base layer 102C are the same grade. That is, the molybdenum powder contains, as unavoidable impurities, iron (Fe) in an amount of 5 ppm or more and 100 ppm or less (preferably 5 ppm or more and 50 ppm or less, more preferably 5 ppm or more and 30 ppm or less), nickel (Ni) in an amount of 5 ppm or more and 40 ppm or less (preferably 5 ppm or more and 20 ppm or less), and potassium (K) in an amount of 5 ppm or more and 30 ppm or less (preferably 5 ppm or more and 20 ppm or less). The total amount of unavoidable impurities of iron (Fe), nickel (Ni), and potassium (K) is 15 ppm or more and 100 ppm or less, and preferably 15 ppm or more and 60 ppm or less. Although the strength of the second base layer 102C is inferior to that of the first base layer 102B, as described above, the molybdenum powder contains iron as an unavoidable impurity, so the second base layer 102C can also maintain sufficient strength. Moreover, the strength of the second base layer 102C can be adjusted by controlling (reducing to some extent) the crystal grain size.

Next, the mixed raw powder for the target layer 102A, the mixed raw powder for the first base layer 102B, and the raw powder for the second base layer 102C are laminated and placed in a die, and die-formed under a pressure of 200 MPa or more to obtain a molded body. As one example in which the ratio of the thicknesses of the first base layer 102B and the second base layer 102C is ⅙ or more and 6 or less, the raw powder of the first base layer 102B is laminated to a thickness of one-half of the total thickness of the base layers (10 mm when the total thickness of the base layers is 20 mm), and the raw powder of the second base layer 102C is laminated to a thickness of one-half of the total thickness of the base layers (10 mm when the total thickness is 20 mm). The thickness of the second base layer 102C may be made greater than that of the first base layer 102B. Increasing the proportion of the second base layer 102C improves gas-release characteristics and enhances the cooling effect of the target layer 102A by radiative cooling. In that case, the strength of the anode 102 is adjusted by controlling the crystal grain size of the second base layer 102C to be smaller. A forming pressure of 200-500 MPa is preferred. If the forming pressure is less than 200 MPa, the density of the molded body is insufficient and a high-density sintered body is difficult to obtain, whereas if it exceeds 500 MPa, cracks are likely to occur in the molded body, which is undesirable.

Next, a sintering process of the molded body is performed. To reduce the influence of oxygen as much as possible, it is preferable that the sintering atmosphere be an inert gas atmosphere or a reducing (hydrogen) atmosphere. In this step, sintering is performed at 1800 degrees Celsius or more and 2500 degrees Celsius or less for 1 to 24 hours. Preferably, sintering is performed at 2000 degrees Celsius or more and 2200 degrees Celsius or less. Further, as one example of the configuration in which the coating material 102D is provided on at least a part of the surface excluding the upper surface of the anode 102, a coating layer 102D is formed by plasma spraying, in the atmosphere, a Ti₂O₃—Al₂O₃ thermal-spray material on at least part of the side surface and the back surface of the anode 102 (as illustrated in FIGS. 4 to 7). Thereafter, through forging and machining processes, the anode 102 is produced.

The anode 102 is constituted of a target layer 102A composed mainly of tungsten and containing rhenium, the first base layer 102B composed mainly of molybdenum with carbides added, and the second base layer 102C composed mainly of molybdenum.

Here, the target layer 102A of the anode 102 has a relative density of 90% or more, and its material only needs to have at least one of tungsten (W), molybdenum (Mo), niobium (Nb), tantalum (Ta), rhenium (Re), titanium (Ti), zirconium (Zr), and vanadium (V) as a principal component.

In the first base layer 102B of the anode 102, it suffices that the base material comprises 0.2 wt % or more and 1.5 wt % or less of at least one carbide selected from titanium carbide, hafnium carbide, zirconium carbide, and tantalum carbide, with the balance being molybdenum.

By the above manufacturing method, the anode 102 according to the embodiment described later was produced. The raw powder for the target layer 102A of the anode 102 was a mixed powder having a composition ratio of 10 wt % rhenium powder and 90 wt tungsten powder. As the raw powder for the first base layer 102B of the anode 102, molybdenum powder containing unavoidable impurities and, as carbide powders, titanium carbide and zirconium carbide were mixed by a ball mill. The proportion of titanium carbide was 0.5 wt %, and the proportion of zirconium carbide was 0.08 wt %. As the raw powder for the second base layer 102C of the anode 102, the same molybdenum powder as used for the first base layer 102B was prepared. The unavoidable impurities in the molybdenum powder used were 20 ppm iron, 15 ppm nickel, and 10 ppm potassium.

Using these raw powders, the anode 102 according to the embodiment described later was produced by the aforementioned manufacturing method. The sintering process was performed at 2100 degrees Celsius for 12 hours in a hydrogen atmosphere. The thickness of the first base layer 102B of the sintered body was 10 mm, and the thickness of the second base layer 102C was 10 mm. The thicknesses of the respective base layers 102B and 102C were measured using a scanning electron microscope (SEM) and energy-dispersive X-ray analysis (EDX). The anode 102 is cut in the thickness direction, and the thickness is measured on an observation surface obtained by polishing and etching the cross-section. The thickness of the first base layer 102B is determined from the region in which carbides contained in the first base layer are detected using SEM and EDX. The thickness of the second base layer 102C is the difference between the thickness of the anode 102 and the thickness of the first base layer 102B.

For the sintered body corresponding to the anode 102 of the embodiment, the oxygen and carbon contents were measured for each base layer. The measurement results of the oxygen and carbon contents are shown in Table 1. As shown in Table 1, in the sintered body corresponding to Example 1, the oxygen content of the first base layer 102B was 200 ppm and the carbon content was 550 ppm. Similarly, in the sintered body corresponding to Example 1, the oxygen content of the second base layer 102C was less than 10 ppm (below the detection limit), and the carbon content was 300 ppm. It has been confirmed that, as long as the oxygen content of the first base layer 102B is 300 ppm or less, the number of discharges is zero or almost zero. On the other hand, a Comparative Example 1 was produced using molybdenum powder with reduction conditions different from those of the embodiment and using the same method as the embodiment, and its oxygen and carbon contents were also measured for each base layer.

For the sintered body corresponding to the embodiment and the sintered body corresponding to Comparative Example 1, the crystal grain size (e.g., average crystal grain size) and the Vickers hardness were measured for each base layer. In addition, for the sintered body corresponding to the embodiment and the sintered body corresponding to Comparative Example 1, the flexural strength of the first base layer was measured. The measurement results of the crystal grain size, Vickers hardness, and flexural strength are shown in Table 2.

TABLE 1

| | Oxygen | Carbon | Oxygen | Carbon |
|---|---|---|---|---|
| | Contents | Contents | Contents | Contents |
| | of First | of First | of Second | of Second |
| | Base Layer | Base Layer | Base Layer | Base Layer |
| Example 1 | 200 | 550 | <10 | 300 |
| Example 2 | 300 | 1000 | 30 | 400 |
| Example 3 | 280 | 600 | 35 | 500 |
| Example 4 | 270 | 450 | 50 | 330 |
| Comparative | 400 | 300 | 450 | 600 |
| Example 1 | | | | |
| Comparative | Not | Not | — | — |
| Example 2 | measured | measured | | |
| | (single | (single | | |
| | base | base | | |
| | layer) | layer) | | |

TABLE 2

| | Crystal | Crystal | Vickers | Vickers |
|---|---|---|---|---|
| | Grain Size | Grain Size | hardness | hardness |
| | of First | of Second | of First | of Second |
| | Base Layer | Base Layer | Base Layer | Base Layer |
| Example 1 | 70 | 110 | 250 | 180 |
| Example 2 | 95 | 160 | 210 | 155 |
| Example 3 | 75 | 150 | 240 | 170 |
| Example 4 | 120 | 230 | 170 | 150 |
| Comparative | 100 | 180 | 205 | 160 |
| Example 1 | | | | |
| Comparative | Not | — | Not | — |
| Example 2 | measured | | measured | |
| | (single | | (single | |
| | base | | base | |
| | layer) | | layer) | |

| | Flexural Strength |
|---|---|
| | of First Base Layer |
| Example 1 | 800 |
| Example 2 | 750 |
| Example 3 | 790 |
| Example 4 | 680 |
| Comparative Example 1 | 710 |
| Comparative Example 2 | 700 (single base layer) |

The anode 102 according to the embodiment was incorporated into an X-ray tube 1, a 20,000-cycle test was conducted, and the number of discharges of the anode 102 was examined. The number of discharges was also examined for the anode according to Comparative Example 1. Further, the anode 102′ according to Comparative Example 2 (illustrated in FIG. 9), which has a single base layer 102E made of TZM alloy and has inferior gas-release characteristics, was incorporated into an X-ray tube, a 20,000-cycle test was conducted, and the number of discharges of the anode 102′ was examined. In both the X-ray tube 1 equipped with the anode 102 according to the embodiment, the X-ray tube equipped with the anode according to Comparative Example 1, and the X-ray tube equipped with the anode 102′ according to Comparative Example 2, no vibration defects were observed.

On the other hand, whereas the number of discharges of the anode 102 in the X-ray tube 1 equipped with the anode 102 according to the embodiment was 0 to 3 times, the discharges in the X-ray tube equipped with the anode according to Comparative Example 1 and the X-ray tube equipped with the anode 102′ according to Comparative Example 2 both occurred 15 times.

TABLE 3

| | The Number of |
|---|---|
| | Discharge events |
| Example 1 | 0 |
| Example 2 | 0 |
| Example 3 | 1 |
| Example 4 | 3 |
| Comparative Example 1 | 15 |
| Comparative Example 2 | 15 |

In the above examples, the anode 102 is formed by laminating, in order, the target layer 102A, the first base layer 102B, and the second base layer 102C; however, it is not limited to that case. Further, although the anode 102 has been described for the case of two base layers (the first base layer 102B and the second base layer 102C), it is not limited to that case. For example, the anode 102 may have three or more base layers. For example, in the case of three base layers, they may be laminated in the order of the first base layer 102B, the second base layer 102C, and the first base layer 102B.

As described above, according to the anode 102 and the X-ray tube 1 including the same, while the first base layer 102B maintains sufficient strength of the anode 102, the second base layer 102C can improve the gas-release characteristics of the anode 102. Thus, according to the anode 102 and the X-ray tube 1 including the same, it is possible to reduce the number of discharges in the X-ray tube 1 without causing vibration defects of the X-ray tube 1 originating from thermal deformation of the target layer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A rotating anode for an X-ray tube, comprising, as a laminate, at least a target layer receiving thermal electrons and generating X-rays, a first base layer, and a second base layer, wherein
the target layer is mainly including at least one of tungsten, molybdenum, niobium, tantalum, rhenium, titanium, zirconium, or vanadium,
the first base layer is mainly including molybdenum and contains at least one carbide selected from titanium carbide, hafnium carbide, zirconium carbide, tantalum carbide, and niobium carbide, and
the second base layer is mainly including molybdenum and has lower oxygen and carbon contents than the first base layer.

2. The rotating anode according to claim 1, wherein the first base layer has an oxygen content of 300 ppm or less and a carbon content of 400 ppm or more and 1000 ppm or less.

3. The rotating anode according to claim 2, wherein the second base layer has an oxygen content of 30 ppm or less and a carbon content of 400 ppm or less.

4. The rotating anode according to claim 1, wherein the crystal grain size of the first base layer is smaller than that of the second base layer.

5. The rotating anode according to claim 1, wherein the Vickers hardness of the first base layer is greater than that of the second base layer.

6. The rotating anode according to claim 1, further comprising: a coating containing at least one of titanium oxide, aluminum oxide, silicon oxide, or zirconium oxide, provided on the side circumferential surfaces of the first and second base layers and on the back surface of the second base layer.

7. The rotating anode according to claim 1, wherein the first base layer has a flexural strength of 700 MPa or more at room temperature.

8. An X-ray tube comprising:
a cathode emitting thermal electrons;
the rotating anode according to claim 1; and
a rotor supporting the rotating anode.

9. An X-ray inspection apparatus comprising the X-ray tube according to claim 8.

10. A method for manufacturing the rotating anode for the X-ray tube according to claim 1, the method comprising:
a step of laminating raw material powders; and
a step in which sintering is performed in an inert-gas atmosphere or a reducing atmosphere.
